(19) United States
(12) Patent Application Publication
(10) Pub. No.: US 2022/0375630 A1
(43) Pub. Date: Nov. 24, 2022

(54) TRITIUM INJECTION TECHNIQUES AND RELATED SYSTEMS AND METHODS

(71) Applicant: Commonwealth Fusion Systems LLC, Cambridge, MA (US)

(72) Inventors: Christopher Chrobak, Littleton, MA (US); Kyle Mackenzie Ryan, Concord, MA (US); Walter Shmayda, Rochester, NY (US); Heena Mutha, Somerville, MA (US)

(73) Assignee: Commonwealth Fusion Systems LLC, Cambridge, MA (US)

(21) Appl. No.: 17/751,435

(22) Filed: May 23, 2022

Related U.S. Application Data
(60) Provisional application No. 63/192,302, filed on May 24, 2021.

(51) Int. Cl. G21B 1/15

(52) U.S. Cl. CPC G21B 1/15

(57) ABSTRACT

Techniques are described for delivering a metered flow of tritium gas to a fusion power system at a constant (or substantially constant) flow without feedback control being necessary, and while allowing all (or almost all) of the tritium in a reservoir to be delivered to the system. A constant pressure (isobaric) tritium injection system is described comprising a process chamber, at least part of which is flexible, and a regulating chamber arranged adjacent to the process chamber. Tritium in the process chamber may be pushed out of the injection system by managing the pressure of a regulating gas in the regulating chamber. As the pressure of the regulating gas increases, this causes the process chamber to be compressed due to the flexible portion(s) of the process chamber, thereby increasing the pressure of the tritium gas.

### CROSS-REFERENCE TO RELATED APPLICATIONS

The present application claims the benefit under 35 U.S.C. § 119(e) of U.S. Provisional Patent Application No. 63/192,302, filed May 24, 2021, titled “Isobaric Tritium Injection System,” which is hereby incorporated by reference in its entirety.

### BACKGROUND

Tritium and deuterium are two isotopes of hydrogen that are used to fuel the reaction that takes place in a tokamak fusion reactor. While deuterium can be extracted from water, tritium is extremely rare. As a result, tritium gas is a closely monitored resource in a fusion system.

### SUMMARY

According to some aspects, a tritium injection module is provided comprising a process chamber comprising tritium gas and having at least one outlet, wherein walls of the process chamber include at least one flexible wall, and a regulating chamber arranged adjacent to the process chamber such that at least one wall of the process chamber also forms at least one wall of the regulating chamber.

The foregoing apparatus and method embodiments may be implemented with any suitable combination of aspects, features, and acts described above or in further detail below. These and other aspects, embodiments, and features of the present teachings can be more fully understood from the following description in conjunction with the accompanying drawings.

### BRIEF DESCRIPTION OF DRAWINGS

Various aspects and embodiments will be described with reference to the following figures. It should be appreciated that the figures are not necessarily drawn to scale. In the drawings, each identical or nearly identical component that is illustrated in various figures is represented by a like numeral. For purposes of clarity, not every component may be labeled in every drawing.

FIG. 1 is a block diagram of a tritium delivery system, according to some embodiments;

FIG. 2 is a cross-sectional view of an illustrative tritium injection system, according to some embodiments;

FIGS. 3A-3B are cross-sectional views of the illustrative tritium injection system of FIG. 2 in which the process chamber is full or empty, respectively, according to some embodiments;

FIG. 4 is a cross-sectional view of an illustrative tritium injection system, according to some embodiments;

FIGS. 5A-5B are cross-sectional views of the illustrative tritium injection system of FIG. 4 in which the process chamber is full or empty, respectively, according to some embodiments;

FIG. 6 is a schematic of a linear encoder system suitable for detecting the position of a component of a tritium injection system, according to some embodiments;

FIG. 7 is a block diagram of a first tritium delivery and control system, according to some embodiments; and

FIG. 8 is a block diagram of a second tritium delivery and control system, according to some embodiments.

### DETAILED DESCRIPTION

Tritium gas is a closely monitored resource in a fusion power system due to being radioactive and due to its high cost. Tritium handling systems are generally designed to minimize the gas quantities needed to operate the system, and may for instance try to eliminate dead volumes of tritium and/or attempt to minimize reservoirs of the gas. Due to its importance in the fusion power system, tritium gas must be accurately metered when being delivered to the system to ensure the proper amount is used. Moreover, due to its radioactive nature it is preferable that tritium is stored in a tritium delivery system for only a short time prior to delivery to the fusion power system.

Conventional tritium handling systems store tritium in a constant volume reservoir and deliver tritium to a fusion power system by opening a control valve. As the reservoir is emptied, however, the pressure of the gas in the reservoir drops. To maintain a constant flow of the tritium gas into the fusion power system as the pressure drops, a feedback control system is operated to adjust an output valve. At some point, the pressure of the tritium in the reservoir drops sufficiently that even with the output valve fully open, the outflow of gas from the reservoir is too low to be properly provided to the system. As such, at least some tritium in the reservoir may represent an unusable volume.

While in principle these challenges may be alleviated somewhat by utilizing electronic components such as pumps, pressure gauges, etc., the environment in which a tritium delivery system is arranged is both a high radiation environment and may be subject to high electromagnetic fields from the fusion power system. As a result, many components, especially those comprising semiconductors and/or resistive components, may not function as intended in a tritium delivery system. Moreover, even components that can function in this environment may add complexity and/or additional cost.

The inventors have recognized and appreciated techniques for delivering a metered flow of tritium gas to a fusion power system at a constant (or substantially constant) flow without feedback control being necessary, and while allowing all (or almost all) of the tritium in a reservoir to be delivered to the system. In particular, the inventors have developed a constant pressure (isobaric) tritium injection system comprising a process chamber, at least part of which is able to expand and contract, and a regulating chamber arranged adjacent to the process chamber. Tritium in the process chamber may be pushed out of the injection system by managing the pressure of a regulating gas in the regulating chamber. As the pressure of the regulating gas increases, the force against the process chamber causes the process chamber to contract, thereby increasing the pressure of the tritium gas. Similarly, decreasing the pressure of the regulating gas decreases may cause the tritium gas pressure to decrease as the process chamber expands. The process chamber may in some cases be arranged so that it can be compressed down to a very small size, thereby allowing all, or almost all, of the tritium in the process chamber to be delivered to the fusion power system.

According to some embodiments, the process chamber of the tritium injection system may be a bellows. As such, when the pressure of the gas in the regulating chamber, which is adjacent to at least part of the process chamber bellows, increases, this may cause the process chamber bellows to be compressed, thereby increasing the gas pressure in the bellows. An outlet of the process chamber may be arranged at least partially within the bellows so that a structure within which the outlet is formed contacts an end of the bellows as the bellows empties. As a result of this configuration, very little (or no) tritium gas may remain within the bellows when the end of the bellows contacts the outlet structure.

According to some embodiments, the process chamber and the regulating chamber of the tritium injection system may each be a bellows, with a movable separator forming part of the process chamber bellows and the regulating chamber bellows. As the gas pressure in the regulating chamber increases, this causes the regulating chamber bellows to expand, moving the movable separator toward the process chamber bellows, which in turn causes the process chamber bellows to be compressed. Conversely, as the gas pressure in the regulating chamber decreases, this causes the regulating chamber bellows to be compressed, moving the movable separator away the process chamber bellows, which in turn causes the process chamber bellows to expand.

According to some embodiments, a position of the process chamber and/or the regulating chamber may be measured using a suitable sensor. By measuring this position, the extent to which the process chamber and/or the regulating chamber have expanded or compressed may be determined, and thereby the amount of tritium gas that has been output from the process chamber may be determined. Thus, the sensor may allow for accurate metering of the tritium gas into the fusion power system. The sensor may measure the position of the process chamber and/or the regulating chamber directly, or may measure the position of a structure coupled to the process chamber and/or the regulating chamber. The sensor may in some embodiments comprise a linear encoder including an optical sensor and a scale arranged on the process chamber and/or the regulating chamber (or a structure coupled thereto). Such a sensor may be immune to electromagnetic interference and may be tolerant of high radiation levels.

Following below are more detailed descriptions of various concepts related to, and embodiments of, techniques for tritium injection. It should be appreciated that various aspects described herein may be implemented in any of numerous ways. Examples of specific implementations are provided herein for illustrative purposes only. In addition, the various aspects described in the embodiments below may be used alone or in any combination, and are not limited to the combinations explicitly described herein.

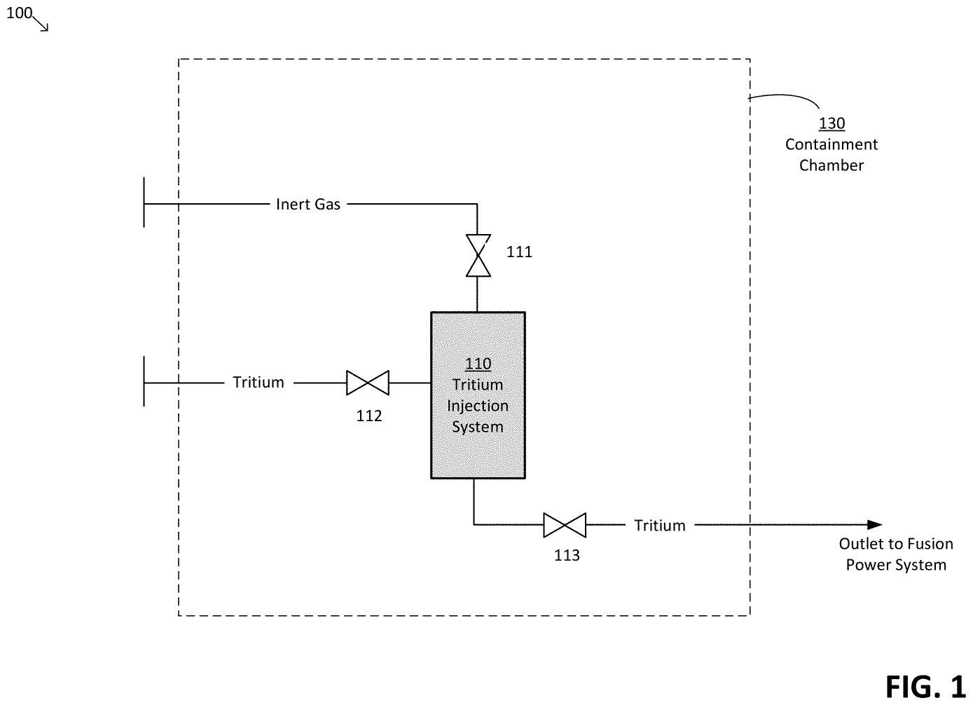

FIG. 1 is a block diagram of a tritium delivery system, according to some embodiments. System 100 includes a tritium injection system 110, examples of which are described below, which receives tritium gas and an inert gas, and outputs tritium gas. As described above, a tritium injection system may comprise a process chamber, at least part of which is flexible, and a regulating chamber arranged adjacent to the process chamber. Tritium in the process chamber may be pushed out of the injection system by managing the pressure of a regulating gas in the regulating chamber. In some embodiments, a process chamber may comprise tritium in addition to one or more other gases.

As referred to herein, a process chamber having at least one flexible wall may include any chamber in which any portion is free to move with respect to another portion of the chamber. As such, any process chamber that is free to expand and contract through relative motion of portions of the process chamber may be considered a process chamber having at least one flexible wall, as used herein.

In the example of FIG. 1, inert gas and tritium may be supplied from a suitable pressurized reservoir (not shown), and their supply into the tritium injection system 110 is modulated by valves 111 and 112, respectively. Output of the tritium held within the tritium injection system 110 may be modulated by the valve 113. The tritium output from the tritium injection system 110 may be supplied to a fusion power system, including but not limited to, a tokamak. For instance, the tritium output from the tritium injection system 110 may be supplied into a vacuum vessel of a tokamak.

According to some embodiments, valve 111 (or another valve coupled to the inert gas supply to tritium injection system 110) may comprise a variable flow rate valve (e.g., a pressure regulator), which may be operated to deliver a constant pressure of inert gas to the tritium injection system. In some embodiments, the tritium may be supplied into the tritium injection system 110 through the same port by which the tritium is output from the system during operation (instead of via a separate port as shown in the example of FIG. 1).

In the example of FIG. 1, the tritium injection system 110 and portions of the gas supply and delivery vessels are arranged within a containment chamber 130, which may be a structure or structures suitable for ensuring that any tritium within it is retained within the containment chamber. In some embodiments, the containment chamber 130 may comprise a glovebox. In some embodiments, the containment chamber 130 may comprise a double-walled pressure vessel.

Tritium is a diffuse gas and often permeates through porous substances and metals, and is further a (weak) beta emitter. The containment chamber 130 may thereby comprise a layer of glass and/or metal that is between 0.1 mm and 5 mm in thickness, to block the beta particles emitted by the tritium from propagating outside the containment chamber. In some embodiments, system 100 may comprise a scavenger bad arranged within or coupled to the containment chamber 130. Tritium that permeates, diffuses or otherwise leaks out of the containment chamber can be reclaimed using a scavenger bed, which is a type of getter configured to trap tritium and allow for subsequent reclamation of the tritium. Illustrative scavenger bed materials may include Zr₂Fe and/or depleted uranium. An inert gas contaminated with tritium can be pumped across the scavenger bed, stripping the gas of the tritium. Subsequently, the tritium within the scavenger bed can be released, e.g., through heating the scavenger bed while passing an inert gas over the bed.

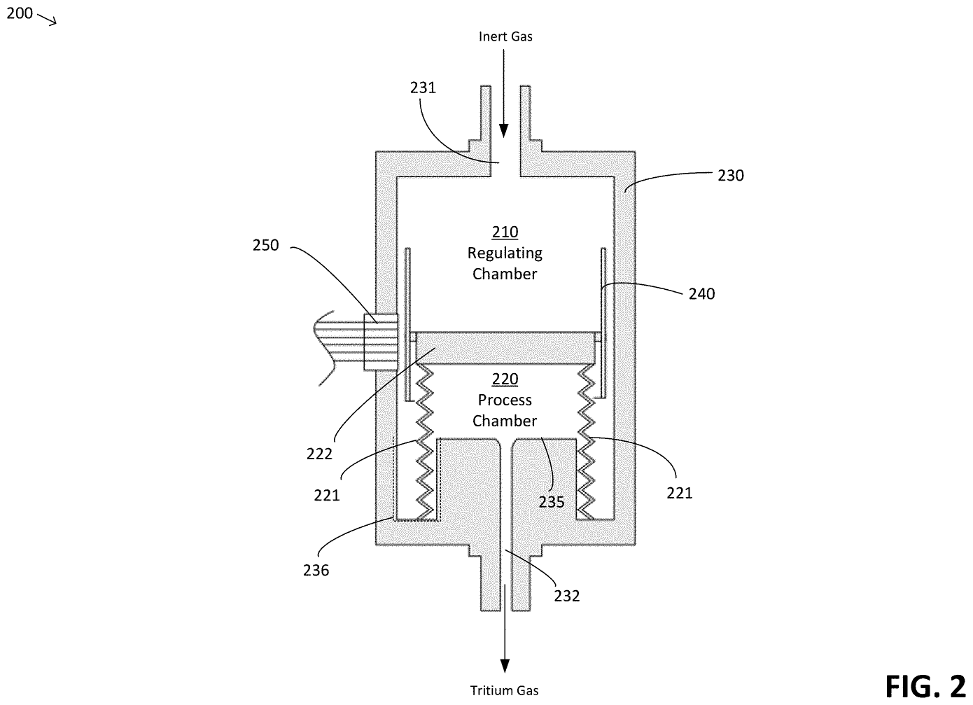

FIG. 2 is a cross-sectional view of an illustrative tritium injection system 200, according to some embodiments. Illustrative tritium injection system 200 comprises a regulating chamber 210 and a process chamber 220. In the example of FIG. 2, the process chamber 220 is configured as a bellows, comprising a flexible side wall 221 (which may for instance be cylindrical) coupled to a movable separator 222 (which may for instance be disc-shaped). The bellows of process chamber 220 may for instance comprise edge welded bellows and/or hydroformed bellows.

In the example of FIG. 2, the regulating chamber 210 is formed by the volume within the container 230 that is exterior to the process chamber 220. As the pressure of tritium gas in the process chamber 220 increases and decreases, the movable separator 222 may move vertically up or down, respectively, within the container 230, expanding or compressing the flexible side wall 221, respectively. As a result, when the process chamber 220 increases in volume the regulating chamber 210 decreases in volume, and vice versa. Consequently, by modulating the pressure in the regulating chamber 210, tritium may be pushed out of the process chamber 220 through outlet 232 with a constant (or substantially constant) flow rate.

As used herein, a “wall” of a chamber may refer to any portion of the structure that encloses a space to form the chamber. Walls may be internal (e.g., may be adjacent to the interior space of the chamber) and/or may be external (e.g., may be adjacent to open space outside of the chamber. Walls may furthermore have any suitable shape, structure and may be formed from any number of materials. As such, it may be understood that the term “wall” may refer to any structure that forms an enclosed space, and may not be limited to any particular physical implementation of such a structure. For instance the moveable sides of the bellows 221 may be considered walls of the process chamber 220.

In the example of FIG. 2, a stopper structure 240 is coupled to the process chamber 220 such that the stopper structure moves vertically within the container 230 as the process chamber expands and contracts. The stopper structure 240 is shown in FIG. 2 as being attached to sides of the movable separator 222, although in general the stopper structure may be coupled to the process chamber in any suitable way, including any direct (physically contacting) or indirect coupling to one or more walls of the process chamber. According to some embodiments, the stopper structure 240 may be almost the width of the container 230 to restrict horizontal motion of the process chamber 220 as the process chamber expands and contracts within the container 230. In some cases, the stopper structure 240 may be, or may comprise, a cylindrical tube.

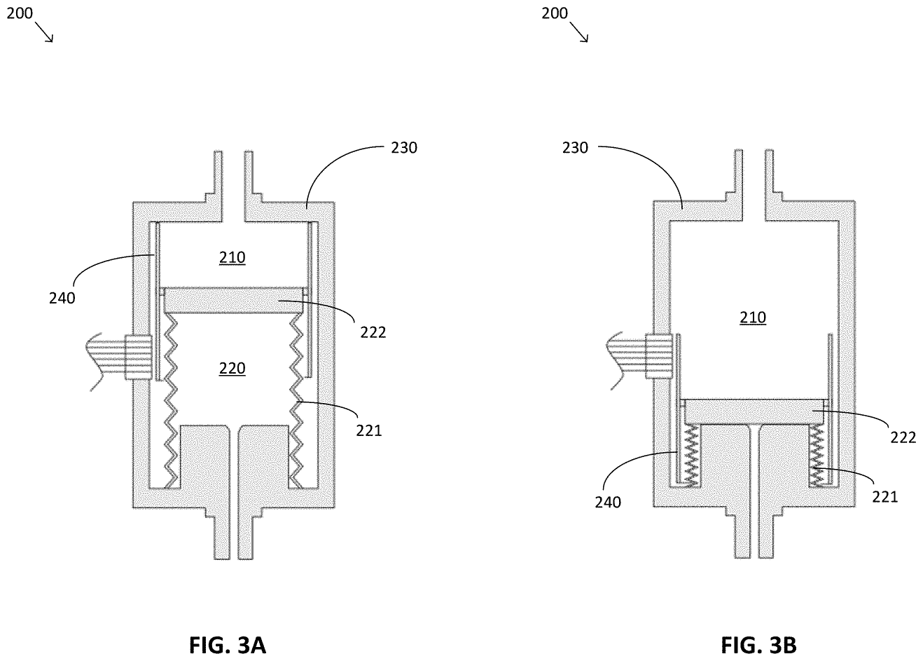

According to some embodiments, the stopper structure 240 may have a vertical size that limits the maximum size of the process chamber 220 as it expands by contacting an interior surface of the container (or other suitable structure), thereby limiting the process chamber from expanding any further. This arrangement is shown in FIG. 3A, which may be considered a “full” state of the process chamber 220. As shown in FIG. 3A, the stopper structure 240 is contacting an upper interior surface of the container 230, thereby inhibiting the process chamber from expanding any further. This configuration may reduce damage to the bellows of process chamber 220 by stopping the bellows from expanding beyond a limit that might reduce the bellows integrity and thereby inhibit long-term repeated expansion and compression. The volume of the process chamber in its full state can be configured with a desired volume by adjusting the position of the uppermost surface of the stopper structure.

As shown in the example of FIGS. 2 and 3A-3B, the bellows 221 may be arranged within a recess 236 at the bottom of the container, with a raised surface 235 arranged within the container 230 and arranged radially inward from the recess. As a result, the moveable separator 222 may contact the raised surface 235 as the process chamber contracts to a zero volume (or close to zero volume since some gas may be present within the recess and inside the bellows), while still providing a space for the bellows. This arrangement is shown in FIG. 3B, which may be considered an “empty” state of the process chamber 220. If the bottom of the bellows and the bottom surface of the container beneath the moveable separator were instead arranged on the same plane, the bellows would need to be compressed to zero size in order to allow the process chamber 220 to have zero size. By providing a space for the bellows, this process chamber can be fully emptied (or almost fully emptied) without compressing the bellows beyond a desired limit. Additionally, or alternatively, the stopper structure 240 may have a vertical size that limits the minimum size of the process chamber 220 as it expands by contacting an interior surface of the container (or other suitable structure), thereby limiting the process chamber from contracting any further. In this approach, the volume of the process chamber in its empty state may be configured with a desired volume by adjusting the position of the lowermost surface of the stopper structure.

Returning to FIG. 2, according to some embodiments the container 230, bellows of process chamber 220, and moveable separator 222 may be formed from a tritium compatible material, such as one or more metals. Such materials may include one or more non-magnetic metals such as 316 series steel, AM-350 steel, and/or a high nickel alloy (e.g., Inconel 718 or 625). The container 230, bellows of process chamber 220, and moveable separator 222 may be formed from the same materials or from different materials.

In the example of FIG. 2, an inert gas is supplied into the regulating chamber 210 via an inlet 231. As described above, the pressure of the tritium gas in process chamber 220 may be controlled by controlling the pressure of the inert gas in the regulating chamber 210. According to some embodiments, the inert gas may be, or may comprise, a noble gas such as helium or argon, and/or nitrogen.

In the example of FIG. 2, tritium gas may be supplied into the process chamber 220 through the channel 232. The channel 232 may be coupled to two different channels, one of which is coupled to a tritium reservoir, and one of which is coupled to a fusion power system, each with corresponding valves that may be operated to direct tritium into the process chamber (e.g., by closing one valve and opening the other), and that may be operated to direct tritium from the process chamber to the fusion power system (e.g., by reversing the state of both valves). Additionally, or alternatively, tritium gas may be supplied into the process chamber 220 through a separate inlet (not shown in the drawing). This additional inlet may, for instance, be arranged on the side of the container 230. In some embodiments, instead of pure tritium, the process chamber 220 may be supplied with, and may contain, tritium in addition to one or more other gases.

According to some embodiments, the pressure of tritium gas within the process chamber 220 may be equal to or greater than 0 bara, 0.5 bara, 1.0 bara, 1.5 bara, 2.0 bara, 2.5 bara, 3.0 bara, or 3.5 bara. According to some embodiments, the pressure of tritium gas within the process chamber 220 may be less than or equal to 4.0 bara, 3.5 bara, 3.0 bara, 2.5 bara, 2.0 bara, 1.5 bara, 1.0 bara, or 0.5 bara. Any suitable combinations of the above-referenced ranges are also possible (e.g., a tritium gas pressure of greater or equal to 0.5 bara and less than or equal to 2.5 bara, etc.).

In the example of FIG. 2, a sensor 250 is coupled to the container 230 and arranged to detect a vertical position of the process chamber 220. The sensor 250 may, for instance, be arranged to detect the vertical position of the process chamber by measuring a position of a wall of the process chamber, and/or by measuring a position of a structure that is rigidly coupled to the process chamber. In the example of FIG. 2, the sensor 250 is configured to measure the vertical position of the stopper structure 240. As shown in FIGS. 3A and 3B, the portion of the stopper structure 240 that is proximate to the sensor 250 changes as the process chamber 220 expands and contracts between full and empty configurations. The sensor 250 may operate as a relative or absolute position encoder, and may operate using optical or any other suitable means.

According to some embodiments, the sensor 250 may comprise a linear encoder. A linear encoder may comprise an optical sensor (e.g., coupled to the interior of the container 230) and a scale (e.g., arranged on the stopper structure 240). A linear encoder is an example of a sensor that may be immune to electromagnetic interference and may be tolerant of high radiation levels, and may therefore be suitable for operation in proximity to tritium gas, and in proximity to a fusion power system.

According to some embodiments, tritium injection system 200 may comprise one or more springs coupled to the movable separator 222 and to the container 230. Such springs may be arranged to balance the pressure between the process chamber and the regulating chamber. For instance, the spring constant of the bellows of process chamber 220 may resist the pressure force applied by regulating chamber 210 to some extent. A spring connecting the movable separator 222 to the bottom of the container 230 may offset this force to some extent, thereby allowing the pressures in the two chambers to more easily equalize.

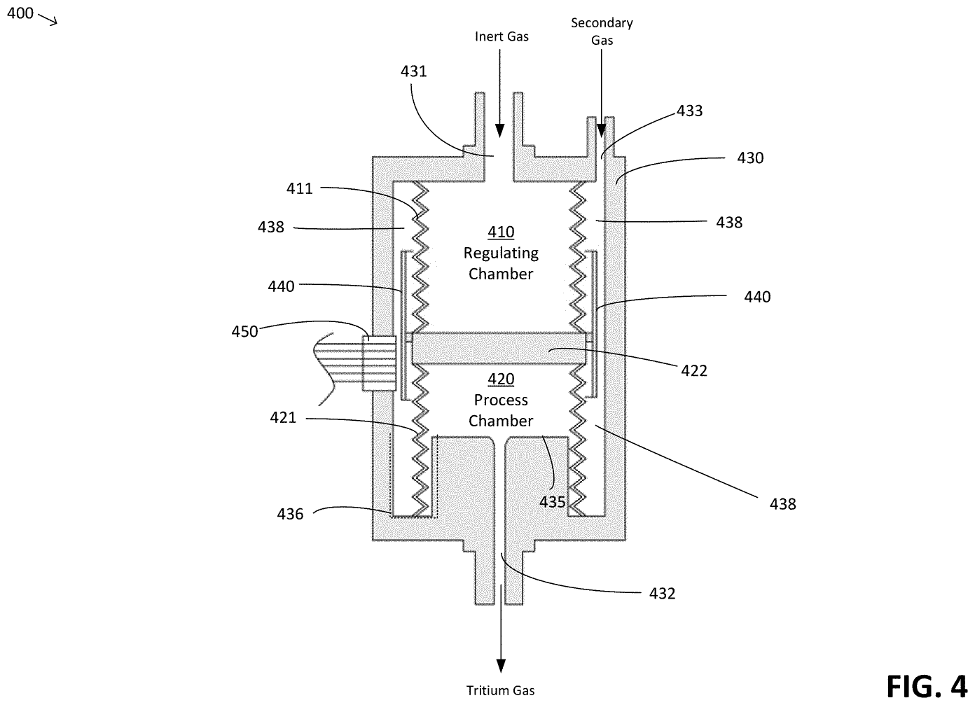

FIG. 4 is a cross-sectional view of an illustrative tritium injection system 400, according to some embodiments. The illustrative design of FIG. 4 exhibits some advantages over the design of FIGS. 2 and 3A-3B. In particular, the tritium injection system 400 is configured so that the regulating chamber 410 also comprises a bellows. This allows a containment region 438 within the container 430 to be separated from both the regulating chamber 410 and process chamber 420. The containment region 438 can be utilized to detect any tritium leaks from the process chamber 420, which can be highly problematic due to the radioactive nature of tritium. In contrast, tritium leaks from the process chamber 220 in tritium injection system 200 may result in tritium mixing with the inert gas in the regulating chamber, which may be difficult to detect, whereas containment region 438 may be filled with a relatively small volume of gas and its pressure monitored as a way to detect a leak of the tritium gas from the process chamber.

In the example of FIG. 4, illustrative tritium injection system 400 comprises a regulating chamber 410 and a process chamber 420, wherein each of the regulating chamber and process chamber is configured as a bellows, comprising a flexible side wall 411 or 421, respectively (each which may for instance be cylindrical), coupled to a movable separator 422 (which may for instance be disc-shaped). Each of the bellows of regulating chamber 410 and process chamber 420 may for instance comprise edge welded bellows and/or hydroformed bellows.

In the example of FIG. 4, as the pressure of inert gas in the regulating chamber 410 increases and decreases, the movable separator 422 may move vertically down or up, respectively, within the container 430, compressing or expanding the flexible side wall 411 and expanding or compressing the flexible side wall 421, respectively. As a result, when the process chamber 420 increases in volume the regulating chamber 410 decreases in volume, and vice versa. Consequently, by modulating the pressure in the regulating chamber 410, tritium may be pushed out of the process chamber 420 through outlet 432 with a constant (or substantially constant) flow rate.

In the example of FIG. 4, the tritium injection system 400 comprises a stopper structure 440 coupled to the regulating chamber 410 and the process chamber 420 such that the stopper structure moves vertically within the container 430 as the process chamber expands and contracts. The stopper structure 440 is shown in FIG. 4 as being attached to sides of the movable separator 222, although in general the stopper structure may be coupled to the process chamber in any suitable way, including any direct (physically contacting) or indirect coupling to one or more walls of the process chamber. According to some embodiments, the stopper structure 440 may be almost the width of the container 430 to restrict horizontal motion of the regulating chamber 410 and process chamber 420 as the regulating chamber and process chamber expand and contract within the container 430. In some cases, the stopper structure 440 may be, or may comprise, a cylindrical tube.

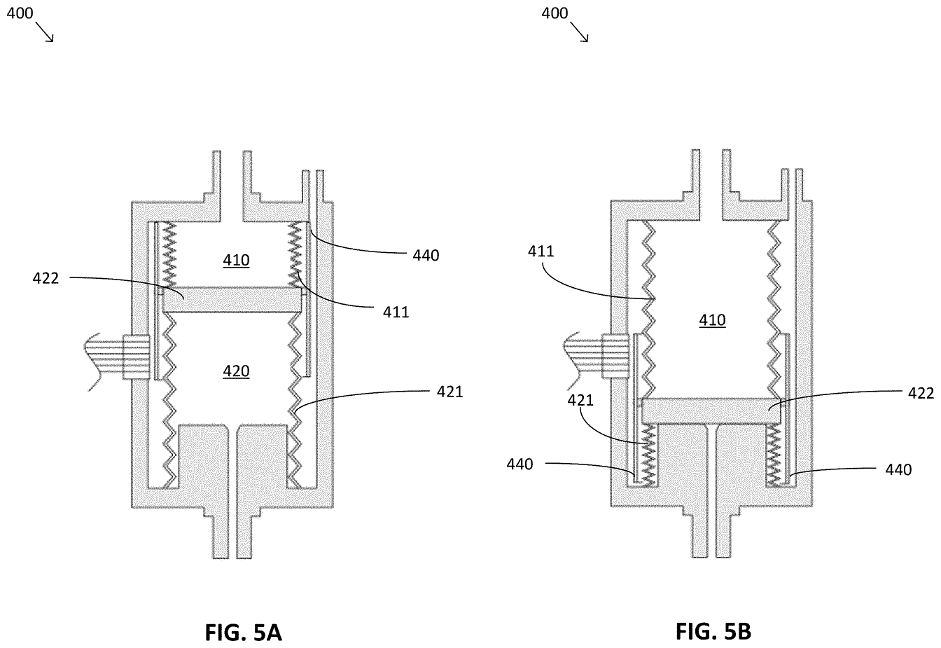

According to some embodiments, the stopper structure 440 may have a vertical size that limits the maximum size of the process chamber 420 as it expands by contacting an interior surface of the container (or other suitable structure), thereby limiting the process chamber from expanding any further. This arrangement is shown in FIG. 5A, which may be considered a “full” state of the process chamber 420. As shown in FIG. 5A, the stopper structure 440 is contacting an upper interior surface of the container 430, thereby inhibiting the process chamber from expanding any further. This configuration may reduce damage to the bellows of process chamber 420 by stopping the bellows from expanding beyond a limit that might reduce the bellows integrity and thereby inhibit long-term repeated expansion and compression. The volume of the process chamber in its full state can be configured with a desired volume by adjusting the position of the uppermost surface of the stopper structure.

As shown in the example of FIGS. 4 and 5A-5B, the bellows 421 may be arranged within a recess 436 at the bottom of the container, with a raised surface 435 arranged within the container 430 and arranged radially inward from the recess. As a result, the moveable separator 422 may contact the raised surface 435 as the process chamber contracts to a zero volume (or close to zero volume since some gas may be present within the recess and inside the bellows), while still providing a space for the bellows. This arrangement is shown in FIG. 5B, which may be considered an “empty” state of the process chamber 420. If the bottom of the bellows and the bottom surface of the container beneath the moveable separator were instead arranged on the same plane, the bellows would need to be compressed to zero size in order to allow the process chamber 420 to have zero size. By providing a space for the bellows, this process chamber can be fully emptied (or almost fully emptied) without compressing the bellows beyond a desired limit. Note that a corresponding recess is not necessary at the top of the container 430, which is planar, since it may not be desirable to empty the regulating chamber and consequently the bellows of the regulating chamber 410 may not be compressed to a great extent, even when the process chamber 420 is full as shown in FIG. 5A. In some embodiments, the stopper structure 440 may have a vertical size that limits the minimum size of the process chamber 420 as it expands by contacting an interior surface of the container (or other suitable structure), thereby limiting the process chamber from contracting any further. In this approach, the volume of the process chamber in its empty state may be configured with a desired volume by adjusting the position of the lowermost surface of the stopper structure.

Returning to FIG. 4, according to some embodiments the container 430, bellows of regulating chamber 410 and process chamber 420, and moveable separator 422 may be formed from a tritium compatible material, such as one or more metals. Such materials may include one or more non-magnetic metals such as 316 series steel, AM-350 steel, and/or a high nickel alloy (e.g., Inconel 718 or 625). The container 430, bellows of process chamber 420, and moveable separator 422 may be formed from the same materials or from different materials.

In the example of FIG. 4, an inert gas is supplied into the regulating chamber 410 via an inlet 431. As described above, the pressure of the tritium gas in process chamber 420 may be controlled by controlling the pressure of the inert gas in the regulating chamber 410. According to some embodiments, the inert gas may be, or may comprise, a noble gas such as helium or argon, and/or nitrogen.

In the example of FIG. 4, tritium gas may be supplied into the process chamber 420 through the channel 432. The channel 432 may be coupled to two different channels, one of which is coupled to a tritium reservoir, and one of which is coupled to a fusion power system, each with corresponding valves that may be operated to direct tritium into the process chamber (e.g., by closing one valve and opening the other), and that may be operated to direct tritium from the process chamber to the fusion power system (e.g., by reversing the state of both valves). Additionally, or alternatively, tritium gas may be supplied into the process chamber 420 through a separate inlet (not shown in the drawing). This additional inlet may, for instance, be arranged on the side of the container 430. In some embodiments, instead of pure tritium, the process chamber 420 may be supplied with, and may contain, tritium in addition to one or more other gases.

As noted above, containment region 438 may be utilized to detect leaks of tritium from the process chamber 420. According to some embodiments, the containment region 438 may comprise a secondary gas supplied into the containment region via inlet 433. The secondary gas may be the same gas, or a different gas, than the inert gas supplied to the regulating chamber 410. In some embodiments, the same gas from the same supply (e.g., a helium supply) may be delivered to both the regulating chamber and the containment region, though delivery to both vessels may be modulated using different equipment (e.g., different valves). In some embodiments, the containment region may be coupled to a pressure sensor configured to detect a tritium leak by measuring the pressure in the containment region over time. For instance, when the measured pressure in the containment region is determined to increase, this may signify a tritium leak. In some embodiments, the containment region may be coupled to a closed loop gas recirculating system passing the secondary gas over a tritium monitor.

According to some embodiments, tritium injection system 400 may comprise one or more springs coupled to the movable separator 422 and to the container 430. Such springs may be arranged to balance the pressure between the process chamber and the regulating chamber. For instance, the spring constant of the bellows of process chamber 420 may resist the pressure force applied by regulating chamber 410 to some extent. A spring connecting the movable separator 422 to the bottom of the container 430 may offset this force to some extent, thereby allowing the pressures in the two chambers to more easily equalize. In some cases, one or more springs connecting the movable separator 422 to the container 430 (at the top, bottom, or both) may allow the pressure of tritium gas in process chamber 420 to be maintained at a desired pressure that is a fixed amount above or below the pressure of the regulating gas in chamber 410.

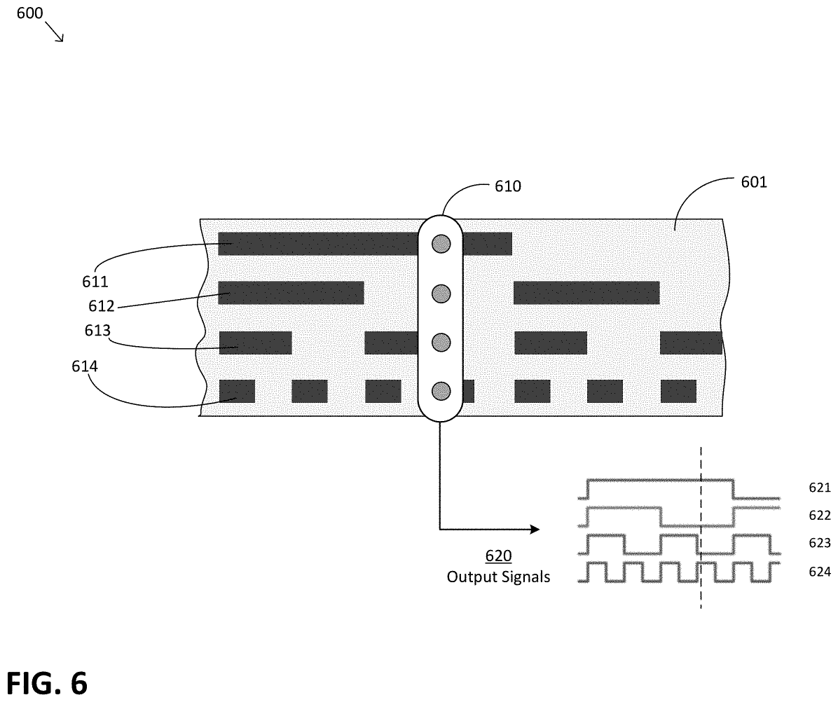

FIG. 6 is a schematic of a linear encoder system suitable for detecting the position of a component of a tritium injection system, according to some embodiments. As described above, one type of sensor suitable for detecting the vertical position of a process chamber of a tritium injection system is a linear encoder. FIG. 6 depicts one example of such an encoder, and may linear encoder 600 may be utilized as, for instance, sensor 250 shown in FIG. 2, or sensor 450 shown in FIG. 4.

In the example of FIG. 6, the linear encoder 600 includes a scale 601 and an array of optical sensors 610. The two components of the linear encoder—the scale and array of optical sensors—may be arranged so that a first one of the components is coupled to the process chamber of a tritium injection system, with the other component of the linear encoder coupled to another structure that moves relative to the first component. For instance, the array of optical sensors may be coupled to the side of the process chamber (or a structure attached thereto), with the scale coupled to a container that contains the process chamber; or the array of optical sensors may be coupled to a container that contains the process chamber, with the scale coupled to the side of the process chamber (or a structure attached thereto).

Irrespective of how the illustrative linear encoder 600 is deployed in a tritium injection system, the illustrative scale 601 may include any number of horizontal features that include alternating dark and light bands at different horizontal length scales. In the example of FIG. 6, features 611-614 are included. The array of optical sensors may include one or more photo detectors (or other suitable sensors) arranged over each of the horizontal features so that sensor data produced by the array of optical sensors indicates whether the features below the array are presenting dark or light portions of the bands. Illustrative output signals 620 for the four illustrative optical sensors shown in FIG. 6 are shown, with the signals 621, 622, 623 and 624 corresponding to the output of each of the sensors arranged over features 611, 612, 613 and 614, respectively, as the array and scale move relative to one another. In this example, a high value represents a dark band and a low value represents a lighter band (or absence of the dark band). The signals produced at the depicted relative horizontal position of the array 610 and scale 601 in FIG. 6 is identified by the vertical dashed line over the output signals 620.

As such, the relative position of the array 610 and scale 601 may be determined to any position within the horizontal extent shown in FIG. 6, with the smallest distance that can be resolved is a result of by the size of the smallest bands 614 (that is, while moving over one of the smallest bands, the output signals will not change).

It will be appreciated that various other implementations of linear encoders may be envisioned, and the techniques described herein are not limited to the particular implementation shown in FIG. 6.

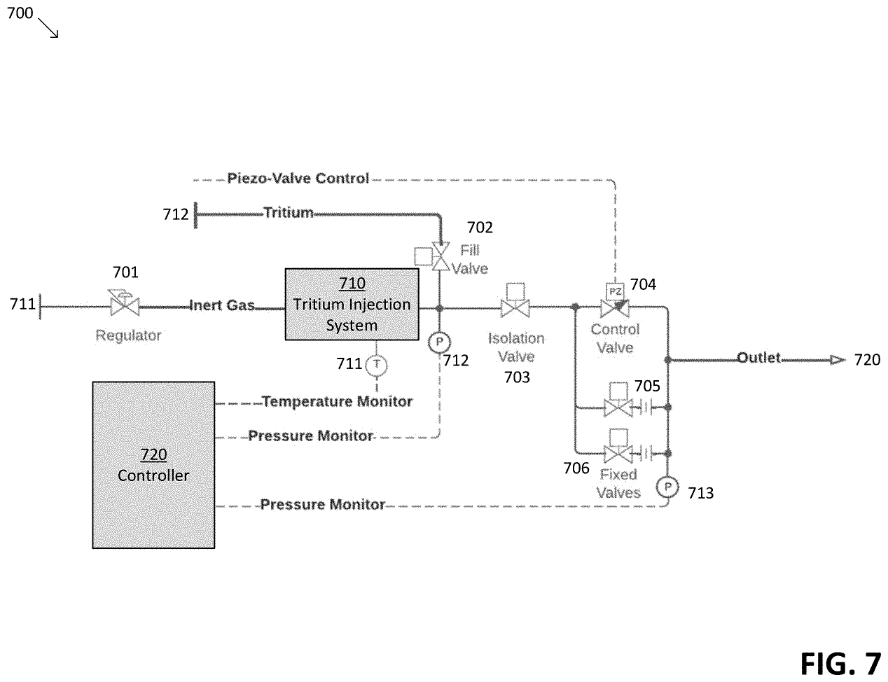

FIG. 7 is a block diagram of a first tritium delivery and control system, according to some embodiments. System 700 includes a tritium injection system 710 which may for instance include any of the tritium injection systems described herein, including system 200 shown in FIG. 2 or system 400 shown in FIG. 4. The illustrative system 700 depicts additional components that may be coupled to the tritium injection system to aid in its operation. In the subsequent discussion of FIG. 7, it may be appreciated that where tritium gas is discussed, this gas may instead be mixture of tritium gas and one or more other gases.

In the example of FIG. 7, system 700 includes a regulator 701 coupled to a source of inert gas 711, and which may be operated to maintain a desired pressure of the inert gas within a regulating chamber of the tritium injection system 710. The regulator may automatically maintain a desired pressure of inert gas within the tritium injection system 710. In the example of FIG. 7, fill valve 702 may be coupled to a tritium gas source 712, and may be opened when filling the process chamber with tritium gas. Isolation valve 703 may be closed during this filling process, but may be opened (and fill valve 702 closed) when outputting tritium from the injection system 710 to the fusion power system via outlet 720. The isolation valve may be included for safety purposes, and to stop any flow of tritium gas to the control valve 704, which also controls whether tritium gas is sent to the outlet 720. In particular, control valve 704 may and provide for a variable flow control with a constant pressure provided by the tritium injection system 710.

In the example of FIG. 7, valves 705 and 706 are examples of simple open/close valves connected in series. These valves may allow for a constant rate of flow through the outlet that is proportional to the pressure of tritium gas in the tritium injection system 710, thereby allowing the flow rate to be controlled with the pressure of the regulating gas in system 710, as described above. Valves 705 and 706 also may allow for all electronic components to be arranged outside of the tritium injection system 710, which is desirable for high radiation or high voltage applications in fusion reactors.

In the example of FIG. 7, system 700 includes several sensors that are operated by controller 720. The controller 720 may also control any one or more (including all) of the valves shown in the drawing, although for clarity connecting lines between the controller and those valves are not shown in the drawing. System 700 includes a temperature monitor 711 configured to measure the temperature of the inert gas in the regulating chamber of the tritium injection system 710 and/or to measure the temperature of the tritium gas in the process chamber of the tritium injection system. System 700 also includes a pressure monitor 712 configured to measure the pressure of tritium gas being output from the tritium injection system (or input during filling), and a pressure monitor 713 configured to measure the pressure of tritium gas being sent to the outlet 720. The controller 720 may be configured to receive sensor input from any one or more of these (and other) temperature and pressure sensors, and to control one or more valves in system 700 accordingly. For example, if the pressure monitor 712 indicates that the pressure of tritium during filling of the process chamber of tritium injection system 710 has reached a desired level, the controller may, in response to receiving this sensor input, close the fill valve 702.

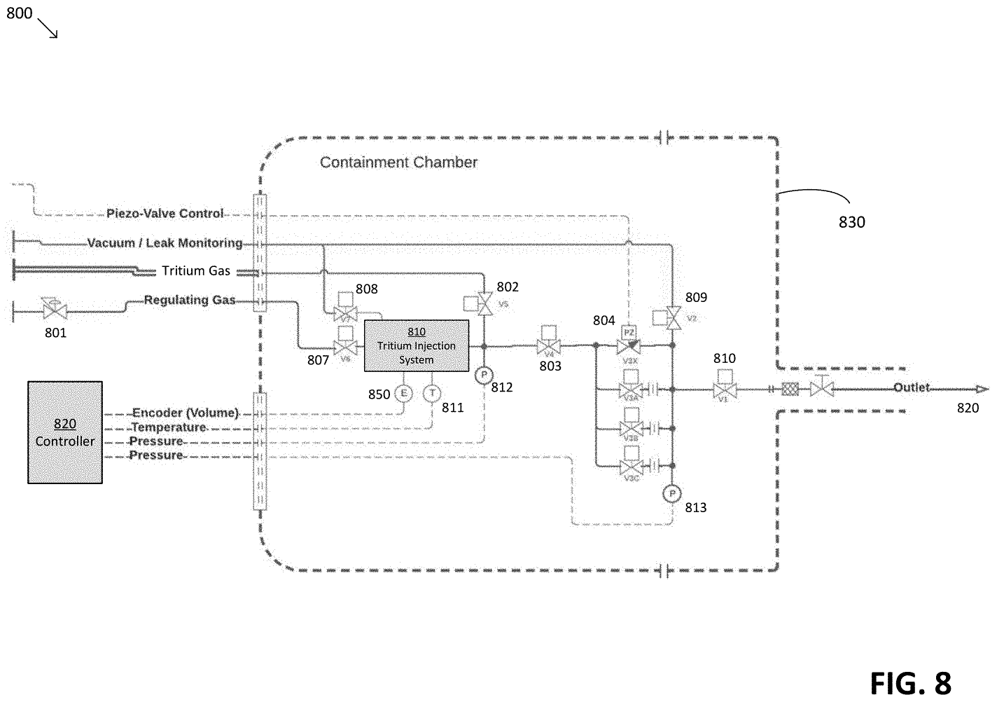

FIG. 8 is a block diagram of a second tritium delivery and control system, according to some embodiments. System 800 includes a tritium injection system 810 which may for instance include any of the tritium injection systems described herein, including system 200 shown in FIG. 2 or system 400 shown in FIG. 4. The illustrative system 800 depicts additional components that may be coupled to the tritium injection system to aid in its operation. In the subsequent discussion of FIG. 8, it may be appreciated that where tritium gas is discussed, this gas may instead be mixture of tritium gas and one or more other gases.

In the example of FIG. 8, system 800 includes a regulator 801 coupled to a source of regulating gas (e.g., inert gas), and which may be operated to maintain, while the valve 807 is open, a desired pressure of the regulating gas within a regulating chamber of the tritium injection system 810. The regulator 801 may automatically maintain a desired pressure of regulating gas within the tritium injection system 810. In the example of FIG. 8, fill valve 802 may be coupled to a tritium gas source, and may be opened when filling the process chamber with tritium gas. Isolation valve 803 may be closed during this filling process, but may be opened (and fill valve 802 closed) when outputting tritium from the injection system 810 to the fusion power system via outlet 820. The isolation valve may be included for safety purposes, and to stop any flow of tritium gas to the control valve 804, which also controls whether tritium gas is sent to the outlet 820. Valves 808 and 809 may be coupled to a leak monitoring system to detect whether any tritium gas is leaking under certain operating circumstances. Valve 808 may be coupled to a containment region within the tritium injection system 810 (e.g., containment region 438 in the example of FIG. 4) to detect leaks in the manner described above.

In the example of FIG. 8, valve 809 may be coupled to a leak detector that is configured to check for leaks across valves 804 when valve 804 is intended to be closed. In contrast, valve 808 can pull vacuum on the tritium injection system and connect to a leak detector to check for leaks coming from the containment chamber 830 into the process line. Such leaks can be detected prior to filling the tritium injection system 810 with tritium, or otherwise.

In the example of FIG. 8, system 800 includes several sensors that are operated by controller 820. The controller 820 may also control any one or more (including all) of the valves shown in the drawing, although for clarity connecting lines between the controller and those valves are not shown in the drawing. System 800 includes a temperature monitor 811 configured to measure the temperature of the regulating gas in the regulating chamber of the tritium injection system 810 and/or to measure the temperature of the tritium gas in the process chamber of the tritium injection system. System 800 also includes a pressure monitor 812 configured to measure the pressure of tritium gas being output from the tritium injection system (or input during filling), and a pressure monitor 813 configured to measure the pressure of tritium gas being sent to the outlet 820. The controller 820 may be configured to receive sensor input from any one or more of these (and other) temperature and pressure sensors, and to control one or more valves in system 800 accordingly. For example, if the pressure monitor 812 indicates that the pressure of tritium during filling of the process chamber of tritium injection system 810 has reached a desired level, the controller may, in response to receiving this sensor input, close the fill valve 802.

In the example of FIG. 8, controller 820 is coupled to a linear encoder 850 which is arranged is proximity to the tritium injection system. The linear encoder 850 and tritium injection system 810 may, for example, be configured in the manner described above for linear encoders 250 and 450 with respect to tritium injection systems 200 and 400, respectively. The controller 820 may be configured to control any one or more (including all) of the valves shown in FIG. 8 based on the output signals produced by one or more optical sensors in the linear encoder 850.

In the example of FIG. 8, the tritium injection system 810 and portions of the gas supply and delivery vessels are arranged within a containment chamber 830, which may be a structure or structures suitable for ensuring that any tritium within it is retained within the containment chamber. In some embodiments, the containment chamber 830 may comprise a glovebox. In some embodiments, the containment chamber 830 may comprise a double-walled pressure vessel. In some embodiments, the containment chamber 830 may be coupled to a closed loop gas recirculating system passing the secondary gas over a tritium monitor.

According to some embodiments, controllers 720 and 820 in the examples of FIGS. 7 and 8 may be implemented using hardware, software or a combination thereof. When implemented in software, the software code can be executed on any suitable processor or collection of processors, whether provided in a single computer or distributed among multiple computers. Such processors may be implemented as integrated circuits, with one or more processors in an integrated circuit component, including commercially available integrated circuit components known in the art by names such as CPU chips, GPU chips, microprocessor, microcontroller, or co-processor. Alternatively, a processor may be implemented in custom circuitry, such as an ASIC, or semi-custom circuitry resulting from configuring a programmable logic device. As yet a further alternative, a processor may be a portion of a larger circuit or semiconductor device, whether commercially available, semi-custom or custom. As a specific example, some commercially available microprocessors have multiple cores such that one or a subset of those cores may constitute a processor. Though, a processor may be implemented using circuitry in any suitable format.

Having thus described several aspects of at least one embodiment of this invention, it is to be appreciated that various alterations, modifications, and improvements will readily occur to those skilled in the art.

Such alterations, modifications, and improvements are intended to be part of this disclosure, and are intended to be within the spirit and scope of the invention. Further, though advantages of the present invention are indicated, it should be appreciated that not every embodiment of the technology described herein will include every described advantage. Some embodiments may not implement any features described as advantageous herein and in some instances one or more of the described features may be implemented to achieve further embodiments. Accordingly, the foregoing description and drawings are by way of example only.

Various aspects of the present invention may be used alone, in combination, or in a variety of arrangements not specifically described in the embodiments described in the foregoing and is therefore not limited in its application to the details and arrangement of components set forth in the foregoing description or illustrated in the drawings. For example, aspects described in one embodiment may be combined in any manner with aspects described in other embodiments.

Also, the invention may be embodied as a method, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

The terms “approximately” and “about” may be used to mean within ±20% of a target value in some embodiments, within ±10% of a target value in some embodiments, within ±5% of a target value in some embodiments, and yet within ±2% of a target value in some embodiments. The terms “approximately” and “about” may include the target value. The term “substantially equal” may be used to refer to values that are within ±20% of one another in some embodiments, within ±10% of one another in some embodiments, within ±5% of one another in some embodiments, and yet within ±2% of one another in some embodiments.

The term “substantially” may be used to refer to values that are within ±20% of a comparative measure in some embodiments, within ±10% in some embodiments, within ±5% in some embodiments, and yet within ±2% in some embodiments. For example, a first direction that is “substantially” perpendicular to a second direction may refer to a first direction that is within ±20% of making a 90° angle with the second direction in some embodiments, within ±10% of making a 90° angle with the second direction in some embodiments, within ±5% of making a 90° angle with the second direction in some embodiments, and yet within ±2% of making a 90° angle with the second direction in some embodiments.

Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

What is claimed is:

1. A tritium injection module comprising:
a process chamber comprising tritium gas and having at least one outlet, wherein walls of the process chamber include at least one flexible wall; and
a regulating chamber arranged adjacent to the process chamber such that at least one wall of the process chamber also forms at least one wall of the regulating chamber.

2. The tritium injection module of claim 1, wherein the process chamber is a bellows.

3. The tritium injection module of claim 2, wherein the regulating chamber is a bellows.

4. The tritium injection module of claim 3, further comprising a movable separator, wherein the at least one wall of the process chamber that also forms the at least one wall of the regulating chamber includes the movable separator.

5. The tritium injection module of claim 4, wherein the movable separator is a rigid wall coupled to the at least one flexible wall of the process chamber and coupled to at least one flexible wall of the regulating chamber.

6. The tritium injection module of claim 5, further comprising a container surrounding the process chamber and the regulating chamber.

7. The tritium injection module of claim 6, wherein the process chamber is coupled to a stopper that contacts an inner surface of the container when the process chamber expands to a first amount and/or contracts to a second amount.

8. The tritium injection module of claim 6, wherein the container comprises at least one inlet for supplying gas to sides of the process chamber bellows and the regulating chamber bellows.

9. The tritium injection module of claim 8, further comprising a leak detector coupled to the at least one inlet of the container and configured to measure a pressure of gas within the container and outside of the process chamber and regulating chamber.

10. The tritium injection module of claim 1, further comprising a linear encoder configured to measure an amount of the tritium gas within the process chamber.

11. The tritium injection module of claim 6, further comprising a scale coupled to the process chamber, and a linear encoder coupled to the container and configured to measure a position of the scale.

12. The tritium injection module of claim 1, wherein the process chamber is arranged within the regulating chamber, with a plurality of walls of the process chamber forming inner walls of the regulating chamber.

13. The tritium injection module of claim 12, wherein the process chamber is coupled to a stopper that contacts an inner surface of the regulating chamber when the process chamber expands to a first amount and/or contracts to a second amount.

14. The tritium injection module of claim 1, wherein the regulating chamber comprises at least one inlet.

15. The tritium injection module of claim 1, wherein the regulating chamber comprises an inert gas.

16. The tritium injection module of claim 1, wherein the process chamber comprises a non-magnetic stainless steel.

17. A fusion reactor comprising the tritium injection module of claim 1.

18. The fusion reactor of claim 17, further comprising a radioactive containment chamber surrounding the tritium injection module.
